(19) United States
(12) Patent Application Publication
(10) Pub. No.: US 2018/0015953 A1
(43) Pub. Date: Jan. 18, 2018

(54) VEHICLE FRONT PORTION STRUCTURE

(71) Applicant: TOYOTA JIDOSHA KABUSHIKI KAISHA, Toyota-shi (JP)

(72) Inventor: Satoshi AJISAKA, Okazaki-shi (JP)

(73) Assignee: TOYOTA JIDOSHA KABUSHIKI KAISHA, Toyota-shi (JP)

(21) Appl. No.: 15/617,618

(22) Filed: Jun. 8, 2017

(30) Foreign Application Priority Data
Jul. 13, 2016 (JP) 2016-138836

(51) Int. Cl. B62D 21/15; B60N 2/01; B60H 1/32; B60K 26/02; B60H 1/00; B60K 1/04; B62D 25/14; B60K 7/00

(52) U.S. Cl. CPC B62D 21/152; B62D 25/14; B60N 2/01; B60K 7/0007; B60K 26/02; B60H 1/00514; B60K 1/04; B60H 1/3227; B60H 1/00535; B60K 2001/0438

(57) ABSTRACT

A vehicle front portion structure comprising: a dash panel that extends in a vehicle transverse direction at a front portion of a vehicle and that partitions a vehicle cabin interior and a vehicle cabin exterior; a protruding portion that is formed by making a center of the dash panel in the vehicle transverse direction protrude towards the front of the vehicle; and a deforming component that is disposed in a vehicle cabin exterior space in front of the protruding portion, and can be deformed by receiving an impact from the front of the vehicle.

### CROSS-REFERENCE TO RELATED APPLICATION

This application is based on and claims priority under 35 USC 119 from Japanese Patent Application No. 2016-138836 filed on Jul. 13, 2016, the disclosure of which is incorporated by reference herein.

### BACKGROUND

### Technical Field

The present invention relates to a vehicle front portion structure.

### Related Art

A vehicle body structure for an automobile that is provided with a driver's seat that is disposed in a central portion in a vehicle transverse direction on top of a vehicle cabin floor, and a pair of rear seats that overlap with a rear portion of the driver's seat when seen in a side view, and that are disposed so as to sandwich the driver's seat from the left and right in a plane view is disclosed in Japanese Patent Application Laid-Open (JP-A) No. 2008-30517.

Inside a vehicle cabin, if the driver's seat is disposed further towards the vehicle front side, then a larger space can be secured at the rear of the driver's seat.

However, it is common for a crushable area that absorbs an impact from the front by deforming in the vehicle front-rear direction to be provided in a front portion of a vehicle.

In such cases, if the driver's seat is simply located closer to the vehicle front side, then the stroke of this crushable area is shortened.

Namely, there is room for improvement from the standpoint of securing large space inside a vehicle cabin, while at the same time securing an impact absorption performance in a frontal collision.

### SUMMARY

In view of the above-described circumstances, it is an object of the present application to secure large space inside a vehicle cabin, and at the same time to secure an impact absorption performance in a frontal collision.

In a first aspect there are provided a dash panel that extends in a vehicle transverse direction at a front portion of a vehicle and forms a partition between a vehicle cabin interior and a vehicle cabin exterior, a protruding portion that is formed by making a center of the dash panel in the vehicle transverse direction protrude towards the front of the vehicle, and a deforming component that is disposed in a vehicle cabin exterior space in front of the protruding portion, and can be deformed by receiving an impact from the front.

Because there is provided a protruding portion that is formed by causing the dash panel to protrude towards the front of the vehicle, a larger space can be secured inside the vehicle cabin compared to a vehicle front portion structure having a dash panel without a protruding portion.

The deforming component is disposed in a space outside the vehicle cabin at the front of the protruding portion. During a frontal collision, the deforming component is deformed by a load from the front of the vehicle. Accordingly, compared with a vehicle whose front portion structure does not have a deforming component, a superior impact absorption performance can be secured in the event of a frontal collision.

In a second aspect, a seat is disposed at the rear of the protruding portion in the vehicle cabin interior.

When viewed from the vehicle cabin interior, the protruding portion is a recessed portion in which the dash panel is recessed towards the front side of the vehicle.

In a third aspect, an internal width dimension on the vehicle rearward side of the protruding portion is larger than a width of the seat that is disposed at the rear of the protruding portion.

By doing this, it is possible to secure sufficient width in the space that is created by the recessed portion at the front of the vehicle seat. For example, it is possible to secure excellent legroom for a vehicle occupant (i.e., a seated passenger) who is sitting in this seat.

In a fourth aspect, an air-conditioning unit is provided in the vehicle front portion structure that air-conditions the vehicle cabin interior, wherein the air-conditioning unit also functions as the deforming component.

Because the air-conditioning unit also functions as the deforming component, there is no need for a new deforming component to be provided, so that any increase in the number of components can be kept in check.

In a fifth aspect, a pair of vehicle framework components that are disposed on the left and right in the vehicle transverse direction and extend in a vehicle front-rear direction are provided in the front portion of the vehicle, and the air-conditioning unit has a mounting component that is mounted by being suspended between the pair of left and right vehicle framework components, and an air-conditioning unit main body and a condenser that are provided in the mounting component.

If the air-conditioning unit main body and the condenser are provided in the mounting component, then because this mounting component is mounted on the vehicle framework components, the air-conditioning unit can be easily mounted on the vehicle.

Moreover, because the mounting component is suspended between the pair of left and right vehicle framework components, the air-conditioning unit can be stably mounted on a vehicle. Because the air-conditioning unit is positioned between the pair of left and right vehicle framework components, it is able to reliably receive any impact from the front.

In a sixth aspect, the mounting component and the air-conditioning unit main body are formed integrally with each other.

Compared with a structure in which the mounting component and the air-conditioning unit are separate bodies, the number of components can be reduced.

In a seventh aspect, the air-conditioning unit main body and the condenser are disposed next to each other in the vehicle transverse direction.

The air-conditioning unit main body is not positioned at the front or at the rear of the condenser. Because of this, compared with a structure in which the air-conditioning unit main body is positioned at the front or at the rear of the condenser, vehicle traveling wind can be made to strike the condenser to good effect.

According to the technology of the present application, it is possible to secure large space in a vehicle cabin, and at the same time to secure an impact absorption performance in a frontal collision.

### BRIEF DESCRIPTION OF THE DRAWINGS

Exemplary embodiments of the present invention will be described in detail based on the following figures, wherein:

FIG. 1 is a plan view showing a vehicle having a vehicle front portion structure according to a first exemplary embodiment of the present invention;

FIG. 2 is a side view showing a vehicle having the vehicle front portion structure according to the first exemplary embodiment of the present invention;

FIG. 3 is a perspective view showing an air-conditioning unit in the vehicle front portion structure according to the first exemplary embodiment of the present invention;

FIG. 4 is an explanatory view in which a condition of a vehicle having the front portion structure according to the first exemplary embodiment of the present invention and a condition of a vehicle having a front portion structure according to a comparative example during a frontal collision are respectively shown;

FIG. 5 contains graphs qualitatively showing relationships between a deformation stroke and a load during a front collision for a vehicle having the front portion structure according to the first exemplary embodiment of the present invention and a vehicle having the front portion structure according to the comparative example.

### DETAILED DESCRIPTION

A vehicle front portion structure according to a first exemplary embodiment of the present invention will now be described with reference made to the drawings. In each drawing, a vehicle front is indicated by an arrow FR, a right side in the vehicle transverse direction is indicated by an arrow RH, and an upward direction of a vehicle is indicated by an arrow UP.

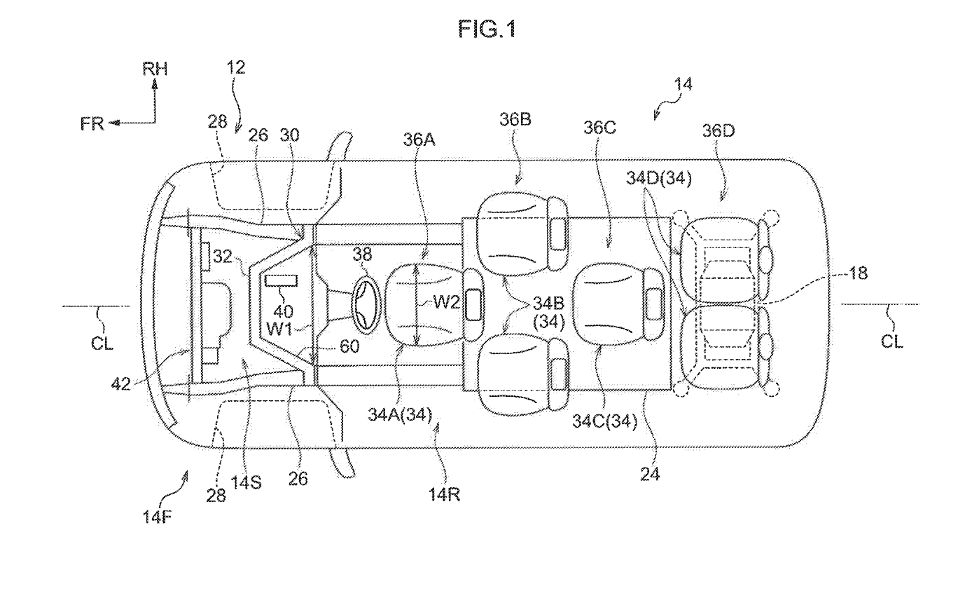

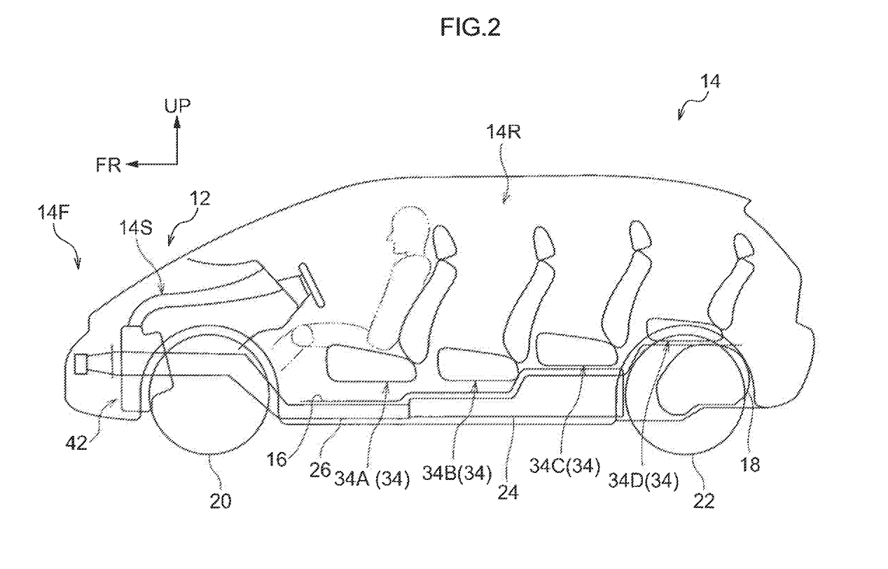

As is shown in FIG. 1 and FIG. 2, a vehicle 14 that is provided with a vehicle front portion structure 12 has a motor 18 that is mounted underneath a floor panel 16 and adjacent to rear wheels 22. In addition, a battery 24 is disposed underneath the floor panel 16 between front wheels 20 and the rear wheels 22. The motor 18 is driven by receiving a power supply from the battery 24. The vehicle 14 travels as a result of drive force from the motor 18 being transmitted to the rear wheels 22. In this way, because the vehicle 14 travels using drive force from the motor 18, there is no need for an engine to be installed.

The vehicle 14 has a pair of front side members 26. The front side members 26 extend respectively in the vehicle front-rear direction (i.e., in the direction shown by the arrow FR and also in the opposite direction to the arrow FR) at a front portion 14F of the vehicle 14. The front side members 26 have a symmetrical structure relative to a centerline CL in the vehicle transverse direction (i.e., in the direction shown by the arrow RH and also in the opposite direction to the arrow RH). The front side members 26 are an example of vehicle framework components that form the framework of the vehicle. If the vehicle 14 is looked at in a plan view, the front side members 26 are positioned between a pair of left and right wheel houses 28 of the front wheels 20.

As is shown in FIG. 1, a dash panel 30 is disposed in the front portion 14F of the vehicle 14. The dash panel 30 is a component that extends overall in the vehicle transverse direction, and is disposed inside the vehicle 14 between a vehicle cabin 14R and a forward space 14S that is located further to the front than this vehicle cabin. The forward space 14S is located outside the vehicle cabin 14R, namely, is an external space in relation to the vehicle cabin.

Each end portion in the vehicle transverse direction of the dash panel 30 is joined via brackets (not shown in the drawings) or by welding or the like respectively to a front side member 26.

A protruding portion 32 that protrudes towards the vehicle front is formed in the center in the vehicle transverse direction of the dash panel 30.

As is shown in FIG. 1, when the vehicle 14 is looked at in a plan view, the dash panel 30 is positioned between the wheel houses 28 of the front wheels 20. In addition, the protruding portion 32 of the dash panel 30 is also positioned between the wheel houses 28.

In this way, because the protruding portion 32 is formed in the dash panel 30, if the dash panel 30 is viewed from inside the vehicle cabin 14R looking towards the front, a recessed portion 60 that is recessed towards the vehicle front side is formed in the location of the protruding portion 32.

A plurality of seats 34 are disposed inside the vehicle cabin 14R. In the present exemplary embodiment, four seat rows 36 are provided starting from the front side of the vehicle. Hereinafter, starting from the vehicle front side, these seat rows 36 are differentiated where appropriate as being a first row 36A, a second row 36B, a third row 36C, and a fourth row 36D.

The first row 36A has a single seat 34A. This seat 34A is disposed in the center in the vehicle transverse direction. Operating components such as a steering wheel 38 and an accelerator pedal 40 and the like are disposed in the vehicle cabin 14R at a position that corresponds to the recessed portion 60 of the dash panel 30. A vehicle occupant who is seated in the seat 34A is able to perform driving operations for the vehicle 14 by operating these operating components. Namely, in the present exemplary embodiment, the seat 34A is the driver's seat. However, in a vehicle in which, for example, the driving has been automated, because driving is not required, the seat 34A does not need to function as the driver's seat.

Moreover, this seat 34A is an example of a seat that is disposed at the rear of the protruding portion 32. As is shown in FIG. 1, an internal width dimension W1 on the vehicle rearward side of the protruding portion 32 is larger than a maximum width W2 of the seat 34A.

The second row 36B has two seats 34B. These seats 34B are separated from each other in the vehicle transverse direction, and are disposed in mutually symmetrical positions relative to the center line CL. Namely, each one of the two seats 34B of the second row 36B is in a different position in the vehicle transverse direction from the seat 34A of the first row 36A. Because of this, as is shown in FIG. 2, when the vehicle is looked at in a side view, even if the seats 34B are placed close to the seat 34A in the vehicle front-rear direction, sufficiently large legroom is still secured for the seated passengers in front of the seats 34B.

The third row 36C has one seat 34C. This seat 34C is disposed in the center in the vehicle transverse direction. Because of this, when the vehicle is looked at in a side view, even if the seat 34C is placed close to the seats 34B in the vehicle front-rear direction, sufficiently large legroom is still secured for the seated passenger in front of the seat 34C.

The fourth row 36D has two seats 34D. These seats 34D are touching each other in the vehicle transverse direction, and are disposed in mutually symmetrical positions relative to the center line CL. Because of this, when the vehicle is looked at in a side view, even if the seats 34D are placed close to the seat 34C in the vehicle front-rear direction, sufficiently large legroom is still secured for the seated passengers in front of the seats 34D. In addition, because the two seats 34D are arranged such that they are touching each other in the vehicle transverse direction, even if the width of the rear portion of the vehicle cabin 14R is narrow, it is still possible to place the two seats 34D next to each other in the vehicle transverse direction.

An air-conditioning unit 42 is disposed in the forward space 14S in a position on the front side of the protruding portion 32.

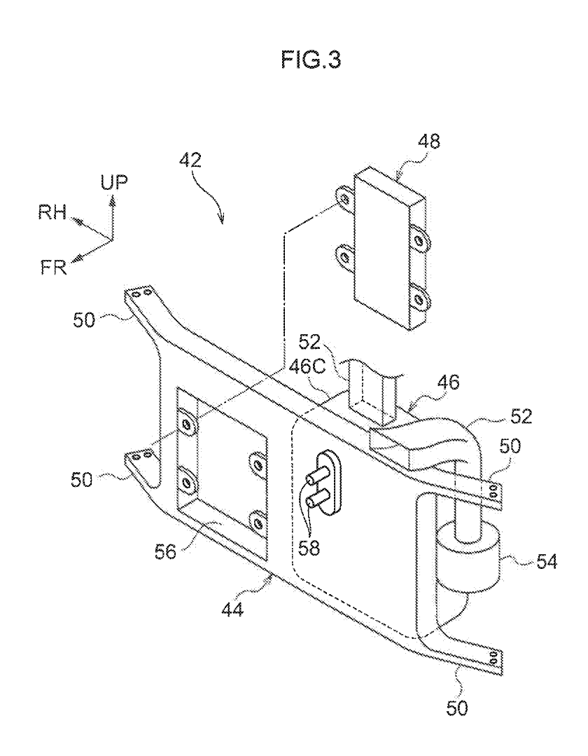

As is shown in detail in FIG. 3, the air-conditioning unit 42 has a mounting component 44, an air-conditioning unit main body 46, and a condenser 48.

The mounting component 44 is a substantially plate-shaped component that extends in the vehicle transverse direction and up-down direction. The mounting component 44 has a plurality of mounting pieces 50. In the example shown in FIG. 3, there are four mounting pieces 50, and these are separated from each other in the up-down direction and also protrude towards the outer sides in the vehicle transverse direction. For example, when the mounting component 44 is suspended between the front side members 26, the mounting component 44 is mounted on the vehicle body via these mounting pieces 50 using bolts or the like.

In the present exemplary embodiment, as is shown in FIG. 1, the air-conditioning unit 42 is separated in the vehicle front-rear direction from the protruding portion 32 of the dash panel 30. The dash panel 30 as well as the instrument panel (not shown in the drawings) that is located above the dash panel 30 may be formed in a black color or in a color close to black in order to suppress reflections therefrom intruding into the vehicle cabin 14R. Even if the dash panel 30 and the instrument panel absorb heat through solar radiation and the like, the air-conditioning unit 42 is located away from the dash panel 30 in a position where it is difficult for this heat to be transmitted to it.

The air-conditioning unit main body 46 and the condenser 48 are disposed next to each other in the vehicle transverse direction. A plurality of air-conditioning pipes 52 are connected to the air-conditioning unit main body 46, and air is introduced from either inside or outside the vehicle cabin 14R by driving a blower motor 54 or the like. The temperature of the introduced air is then adjusted and the air can then be fed to the interior of the vehicle cabin 14R.

A case 46C of the air-conditioning unit main body 46 is made, for example, from resin, and is molded integrally with the mounting component 44. In other words, a structure is employed in which the case 46C is extended in the vehicle transverse direction so as to form the mounting component 44, and the air-conditioning unit main body 46 is mounted on the vehicle framework components by utilizing the mounting component 44 which is an extended portion.

A mounting hole 56 is formed in the mounting component 44 in a lateral position relative to the air-conditioning unit main body 46. The condenser 48 is mounted onto the mounting component 44 via bolts or the like such that the condenser 48 fits inside this mounting hole 56.

The air-conditioning unit main body 46 and the condenser 48 are connected together by refrigerant pipes 58, and the condenser 48 condenses (i.e., liquefies) refrigerant vapor fed from the air-conditioning unit main body 46. Liquefied refrigerant is then returned to the air-conditioning unit main body 46.

The condenser 48 is mounted in the mounting hole 56 of the mounting component 44, and is exposed on the vehicle forward side and on the vehicle rearward side. Additionally, no other components are placed on the vehicle forward side or on the vehicle rearward side in the vicinity of the condenser 48. Because of this, an air flow is easily generated from the vehicle forward side towards the vehicle rearward side with regard to the condenser 48, and heat exchange can be efficiently performed for this air.

If an impact is applied to the vehicle 14 from the front, the structure of the air-conditioning unit 42 enables it to deform so as to absorb this impact. In particular, as is described above, because the mounting component 44 and the air-conditioning unit main body 46 are integrally molded together, the air-conditioning unit 42 is able to absorb such an impact as a result of the mounting component 44 and the air-conditioning unit main body 46 deforming.

Next, effects of the present exemplary embodiment will be described.

In the vehicle 14 having the vehicle front portion structure 12 according to the present exemplary embodiment, the dash panel 30 has the protruding portion 32. When viewed from inside the vehicle cabin 14R, the protruding portion 32 is formed as the recessed portion 60 that is recessed towards the front of the vehicle 14. Because of this, compared with a vehicle that is provided with a dash panel that does not have a protruding portion, a larger space inside the vehicle cabin can be secured. For example, even if a structure is employed in which the overall size of the vehicle 14 (for example, the overall length) is reduced, a large space can be secured inside the vehicle cabin 14R. Reducing the size of the vehicle 14 can also contribute to a reduction in the weight of the vehicle 14.

As is shown in FIG. 1, if the seat 34A is disposed at the rear of the protruding portion 32, then because the recessed portion 60 is provided in front of the seat 34A, this recessed portion 60 makes it possible to secure sufficiently large legroom for a seated occupant of the seat 34A. If the seat 34A is the driver's seat, then the recessed portion 60 can also be used, for example, as the space where the accelerator pedal 40 is disposed.

In particular, the internal width dimension W1 on the vehicle rearward side of the protruding portion 32 is larger than the maximum width W2 of the seat 34A. Because of this, a sufficiently large width can be secured for the space used, for example, to house the leg portion of the seated occupant of the seat 34A. Moreover, operating the accelerator pedal 40 is easy in a structure in which the accelerator pedal 40 and the like are disposed inside the recessed portion 60.

Naturally, even if a structure is employed in which a seat is not provided on the vehicle rearward side of the protruding portion 32, providing the protruding portion 32 in the dash panel 30 means that the recessed portion 60 is present on the vehicle cabin 14R side, so that a larger space can be secured inside the vehicle cabin 14R.

Because the seats 34B in the second row 36B are in different positions in the vehicle transverse direction from the seat 34A in the first row 36A, sufficiently wide legroom for a seated person can be secured on the forward side of the seats 34B. In the same way, sufficiently wide legroom can also be secured for the seat 34C of the third row 36C and the seats 34D of the fourth row 36D.

When an impact is applied from the front to the vehicle 14, the front portion 14F of the vehicle 14 is deformed enabling this impact to be absorbed. In particular, in the vehicle front portion structure 12 of the present exemplary embodiment, because the air-conditioning unit 42 which also functions as the deforming component is provided, the air-conditioning unit 42 is also deformed by the impact acting from the front and is able to absorb this impact. Note that, in the vehicle front portion structure 12 of the present exemplary embodiment, because the protruding portion 32 is provided in the dash panel 30, impact can also be absorbed by the deformation of this protruding portion 32 as well.

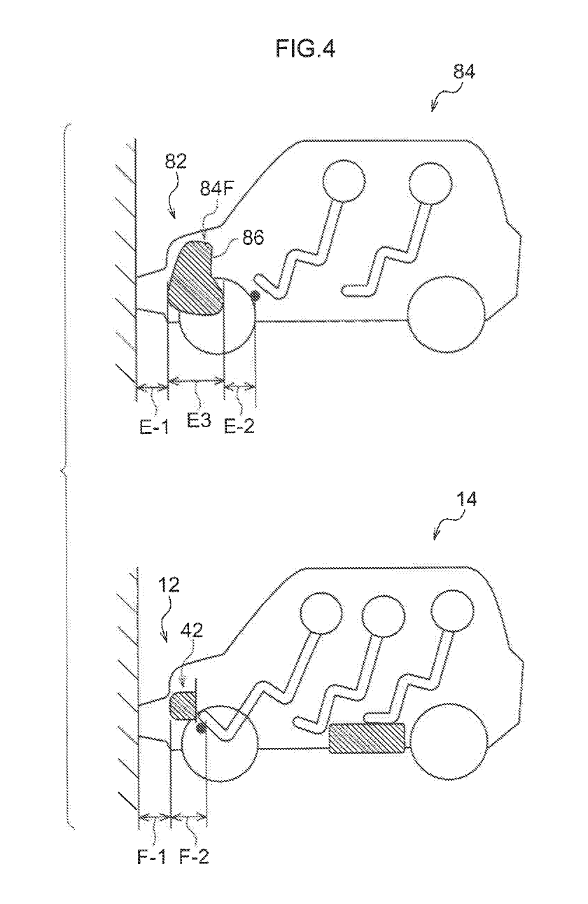

Here, frontal collision states of a vehicle 84 having a vehicle front portion structure 82 according to a comparative example, and of the vehicle 14 having the front portion structure 12 of the present exemplary embodiment are shown in FIG. 4. The vehicle 84 of the comparative example has an engine 86 that is mounted in a front portion 84F thereof. In addition, no portion that corresponds to the protruding portion 32 (see FIG. 1) according to the present exemplary embodiment is formed in the dash panel of the vehicle 84. However, for example, the structure and the like of front side members in the vehicle 84 of the comparative example is the same as the structure of the front side members 26 of the vehicle 14 of the present exemplary embodiment.

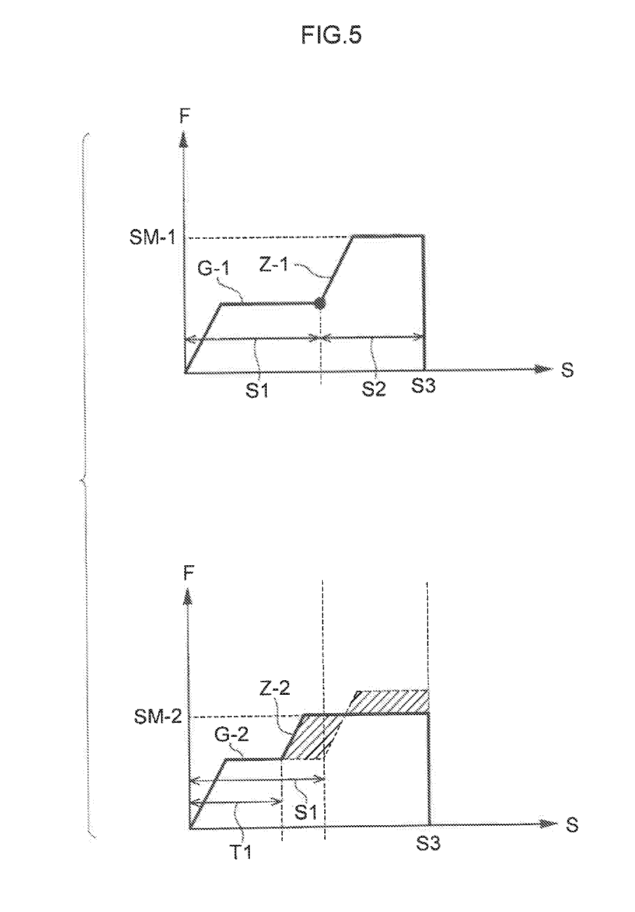

Furthermore, relationships between a deformation stroke S and a load F when an impact is applied from the front to the vehicles 84 and 14 are shown in FIG. 5. In FIG. 5, the upper graph corresponds to the vehicle 84 of the comparative example while the lower graph corresponds to the vehicle 14 of the present exemplary embodiment.

A deformation stroke S3 of the vehicle front portion in response to an impact from the front is set so to be the same in both the vehicle 84 of the comparative example and the vehicle 14 of the present exemplary embodiment. In addition, the quantity of energy capable of being absorbed by this deformation is also set so as to be the same in both the vehicle 84 of the comparative example and the vehicle 14 of the present exemplary embodiment. In each of the graphs shown in FIG. 5, this energy quantity is represented as a surface area (mechanical work) between curves G-1 and G-2 and the horizontal axis.

In the vehicle 84 of the comparative example, during the initial stage of the deformation, of the front portion 84F, mainly an area on the forward side of the engine 86 (i.e., an area E-1 shown in FIG. 4) is deformed. When the deformation stroke reaches a predetermined quantity S1, it becomes difficult for the area E-1 to continue to be deformed. Moreover, it is also difficult for an area E-3 where the engine 86 is mounted to be deformed. Accordingly, in the latter stage of the deformation, of the front portion 84F, mainly an area on the rearward side of the engine 86 (i.e., an area E-2 shown in FIG. 4) is deformed, and the load F increases, so that a load escalation section Z-1 appears in the curve G-1 in the graph. The essential deformation stroke S3 is the sum of the deformation stroke S1 on the forward side of the engine 86 and the deformation stroke S2 on the rearward side thereof. In addition, during the latter stage of the deformation, the load reaches a maximum value SM-1.

In contrast, in the vehicle 14 of the present exemplary embodiment, mainly an area on the forward side of the air-conditioning unit 42 (i.e., an area F-1 shown in FIG. 4) is deformed by the impact applied from the front, however, thereafter, both the air-conditioning unit 42 and an area where the air-conditioning unit 42 is provided (i.e., an area F-2 shown in FIG. 4) are deformed. A load escalation section Z-2 appears in the curve G-2 in the graph.

As can be understood by comparing the upper and lower graphs shown in FIG. 5, a deformation stroke T1 at the point when the area F-2 begins to deform in the present exemplary embodiment is shorter than a deformation stroke S1 at the point when the area E-2 begins to deform in the vehicle 84 of the comparative example. In other words, in the vehicle 14 of the present exemplary embodiment, the load F increases at an earlier timing than in the vehicle 84 of the comparative example. In addition, the load escalation section Z-2 in the curve G-2 appears at an earlier timing than the load escalation section Z-1 of the comparative example. Thereafter, mainly the area F-2 is deformed and reaches the preset deformation stroke S3.

The quantity of energy capable of being absorbed by deformation is set so as to be the same in both the vehicle 84 of the comparative example and the vehicle 14 of the present exemplary embodiment. In the vehicle 14 of the present exemplary embodiment, because the timing when the load F increases (i.e., the load escalation section Z-2 in the graph) is earlier than in the vehicle 84 of the comparative example, in order to obtain the same quantity of energy as obtained from the vehicle 84 of the comparative example, the load maximum value SM-2 only needs to be small. Namely, the impact absorption performance in a frontal collision is better in the vehicle 14 provided with the vehicle front portion structure 12 of the present embodiment than in the vehicle 84 of the comparative example.

The deforming component is not limited to the air-conditioning unit 42. For example, it is also possible to provide a separate deforming component from the air-conditioning unit 42. In the foregoing description, the air-conditioning unit 42 is given as an example of a deforming component. Namely, the air-conditioning unit 42 is constructed such that it additionally functions as a component that deforms during a frontal collision and absorbs the impact therefrom. Because of this, compared with a structure in which the deforming component is separate from the air-conditioning unit 42, any increase in the number of components can be suppressed.

In the above-described exemplary embodiment, the air-conditioning unit 42 is mounted by being suspended between the front side members 26 via the mounting component 44. Accordingly, the air-conditioning unit main body 46 and the condenser 48 of the air-conditioning unit 42 can be stably supported by the vehicle framework components.

It is also possible for the mounting component 44 and the air-conditioning unit main body 46 to be separate components, however, in the above-described exemplary embodiment, the mounting component 44 and the air-conditioning unit main body 46 are formed as an integrated unit. Because of this, compared with a structure in which the mounting component 44 and the air-conditioning unit main body 46 are separate components, fewer parts are required. Moreover, when a deforming load is applied to the mounting component 44, a portion of this load is applied directly from the mounting component 44 to the air-conditioning unit main body 46, so that the air-conditioning unit main body 46 can also be effectively deformed.

The air-conditioning unit main body 46 and the condenser 48 can also be disposed next to each other in the vehicle front-rear direction, however, in the above-described exemplary embodiment, the air-conditioning unit main body 46 and the condenser 48 are disposed next to each other in the vehicle transverse direction. Namely, a structure is employed in which the air-conditioning unit main body 46 is not present on the vehicle forward side or on the vehicle rearward side of the condenser 48. By employing this structure, compared with a structure in which the air-conditioning unit main body 46 is present on the vehicle forward side or on the vehicle rearward side, the flow of traveling wind towards the condenser 48 is not obstructed. Because traveling wind can be made to strike the condenser 48 to good effect, a superior air-conditioning performance can be realized from the air-conditioning unit 42.

The air-conditioning unit 42 is separated from the protruding portion 32 of the dash panel 30, so that it is difficult for heat from the dash panel 30 or the instrument panel to be transmitted to the air-conditioning unit 42. Accordingly, any unexpected temperature increase in the air-conditioning unit 42 can be suppressed, and a superior air-conditioning performance can be achieved particularly within a short time after the driving of the air-conditioning unit 42 has commenced.

In the above-described exemplary embodiment, the vehicle 14 which runs using drive force from the motor 28 is used as an example of a vehicle, however, even if the vehicle is one which runs using drive force from an engine, it is still possible to form the protruding portion 32 in the dash panel 30 provided that a predetermined amount of forward space exists.

What is claimed is:

1. A vehicle front portion structure comprising:
a dash panel that extends in a vehicle transverse direction at a front portion of a vehicle and that partitions a vehicle cabin interior and a vehicle cabin exterior,
a protruding portion that is formed by making a center of the dash panel in the vehicle transverse direction protrude towards the front of the vehicle; and
a deforming component that is disposed in a vehicle cabin exterior space in front of the protruding portion, and can be deformed by receiving an impact from the front of the vehicle.

2. The vehicle front portion structure according to claim 1, wherein a seat is disposed at the rear of the protruding portion in the vehicle cabin interior.

3. The vehicle front portion structure according to claim 2, wherein an internal width dimension on the vehicle rearward side of the protruding portion is larger than a width of the seat that is disposed at the rear of the protruding portion.

4. The vehicle front portion structure according to claim 1, wherein:
an air-conditioning unit is provided in the vehicle front portion structure that air-conditions the vehicle cabin interior, and
the air-conditioning unit also functions as the deforming component.

5. The vehicle front portion structure according to claim 4, wherein a pair of vehicle framework components that are disposed on the left and right in the vehicle transverse direction and extend in a vehicle front-rear direction are provided in the front portion of the vehicle, and
the air-conditioning unit comprises:
a mounting component that is mounted by being suspended between the pair of left and right vehicle framework components; and
an air-conditioning unit main body and a condenser that are provided in the mounting component.

6. The vehicle front portion structure according to claim 5, wherein the mounting component and the air-conditioning unit main body are formed integrally with each other.

7. The vehicle front portion structure according to claim 5, wherein the air-conditioning unit main body and the condenser are disposed next to each other in the vehicle transverse direction.

8. The vehicle front portion structure according to claim 2, wherein:
the seat is a driver's seat, and
an accelerator pedal is disposed at a vehicle cabin interior side of the protruding portion.

9. The vehicle front portion structure according to claim 3, wherein:
the seat is a driver's seat, and
an accelerator pedal is disposed at a vehicle cabin interior side of the protruding portion.
